(19) United States
(12) Patent Application Publication
(10) Pub. No.: US 2017/0046316 A1
(43) Pub. Date: Feb. 16, 2017

(54) MODIFYING A HIERARCHAL STRUCTURE

(71) Applicant: HEWLETT PACKARD ENTERPRISE DEVELOPMENT LP, Houston, TX (US)

(72) Inventors: Ofer Spiegel, Yehud (IL); Talia Lavie, Yehud (IL)

(73) Assignee: Hewlett Packard Enterprise Development LP, Houston, TX (US)

(21) Appl. No.: 15/118,557

(22) PCT Filed: Feb. 14, 2014
(86) PCT No.: PCT/US2014/016393

§ 371 Date: Aug. 12, 2016

(51) Int. Cl. G06F 17/22; G06F 17/24; G06F 3/0484

(52) U.S. Cl. CPC G06F 17/2241; G06F 3/0484; G06F 17/243; G06F 3/0482

(57) ABSTRACT

Modifying a hierarchal structure includes obtaining, from a user interface (UI), data representing categories, levels for the categories, attributes associated with the categories, and attribute values associated with the attributes, restructuring the data with content to generate a hierarchal structure, and modifying, via the UI, the hierarchal structure based on modifications to the data and the content to generate a modified hierarchal structure.

### BACKGROUND

A hierarchical structure is an arrangement of content such as objects, names, values, items, among other content, Further, the hierarchical structure may include a number of hierarchical levels to categorize the content. The hierarchical levels categorize the content as being above, below, or at the same level as other content.

### BRIEF DESCRIPTION OF THE DRAWINGS

The accompanying drawings illustrate various examples of the principles described herein and are a part of the specification. The examples do not limit the scope of the claims,

FIG. 1 is a diagram of an example of a system for modifying a hierarchal structure, according to one example of principles described herein,

FIG. 2 is a diagram of an example of a user interface (UI) for defining, categories, levels for the categories, attributes associated with the levels for the categories, and attribute values associated with the attributes, according to one example of principles described herein.

FIG. 3 is a diagram of an example of a category hierarchical structure representing defined categories, levels for the categories, attributes associated with the levels for the categories, and attribute values associated with the attributes, according to one example of principles described herein.

FIG. 4 is a diagram of an example of a hierarchical structure, according to one example of principles described herein.

FIG. 5 is a diagram of an example of a UI for modifying the hierarchal structure, according to one example of principles described herein.

FIG. 6 is a diagram of an example of a modified hierarchal structure, according to one example of principles described herein,

FIG. 7 is a flowchart of an example of a method for modifying a hierarchal structure, according to one example of principles described herein.

FIG. 8 is a flowchart of an example of a method for modifying a hierarchal structure, according to one example of principles described herein.

FIG. 9 is a diagram of an example of a modifying system, according to one example of principles described herein.

FIG. 10 is a diagram of an example of a modifying system, according to one example of principles described herein.

Throughout the drawings, identical reference numbers designate similar, but not necessarily identical, elements.

### DETAILED DESCRIPTION

As mentioned above, the hierarchical structure may include a number of hierarchical levels to categorize the content. The hierarchical levels within the hierarchical structure can be classified into two distinct hierarchy classifications. The first hierarchical level, such as a category, represents the context of the content. The second hierarchical level of the hierarchy represents the actual breakdown of the content.

For example, in a hierarchy structure for a list of to do items, there can be initial hierarchy levels representing a person, a domain of work, or other hierarchy levels. In one example, these top level hierarchies may be referred to as categories. The categories are often also represented as attributes of the actual content.

Often, a user will modify the hierarchy structure. However, the categories are fixed and cannot be modified dynamically. Moreover, the categories are not bound to attribute values corresponding to the categories and therefore content may be placed under a given category that does not have a corresponding attribute that carries the same attribute value. As a result, if the hierarchy structure is modified, the content may not be placed in an appropriate category. This can lead to an erroneous representation of the categories and the content.

Further, if a hierarchically structured content is restructured by a virtual hierarchy, the physical hierarchy of the hierarchically structured data is removed and the content is flattened under each category. Further, the virtual hierarchy flattening the content does not permit adding new content to the hierarchy structure.

The principles described herein include a method for modifying a hierarchal structure. Such a method includes obtaining, from a user interface (UI), data representing categories, levels for the categories, attributes associated with the levels for the categories, and attribute values associated with the attributes, restructuring the data with content to generate a hierarchal structure, modifying, via the UI, the hierarchal structure based on modifications to the data and the content to generate a modified hierarchal structure. Such a method allows new content to be added, removed, or rearranged in the hierarchal structure to generate a modified hierarchal structure. As a result, the content is not flattened under the levels for the categories in the modified hierarchal structure.

In the present specification and in the appended claims, the term “data” is meant to be understood broadly as information that is used to define categories, levels for the categories, attributes associated with the levels for the categories, and attribute values associated with the attributes. In one example, the levels for the categories determine which categories, are above, below, or at the same level as other categories. In one example, the categories may be attributes such as domain, person, or other attributes. Further, an attribute may include a number of attribute values. In one example, attribute values may be work, home, school, or other attribute values. Further, the categories attributes correspond to attributes of the hierarchically structured content.

In the present specification and in the appended claims, the term “content” is meant to be understood broadly as items associated with a category, an attribute, an attribute value, or combinations thereof. In one example content may include objects, names, values, other content, or combinations thereof. In one example, the content may be specified in a data structure such as a physical tree.

In the present specification and in the appended claims, the term “hierarchal structure” is meant to be understood broadly as arrangement of content corresponding to categories, levels for the categories, attributes, attribute values, or combinations thereof. In one example, the hierarchal structure may include a physical hierarchy. In this example, the physical hierarchy may be an inherent structure of the content. Further, the hierarchal structure may include a virtual hierarchy. In this example, the virtual hierarchy may be a structure for the categories. In one example, the hierarchal structure may be a combination of the physical hierarchy and the virtual hierarchy in which the virtual hierarchy is superimposed on top of the physical hierarchy.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

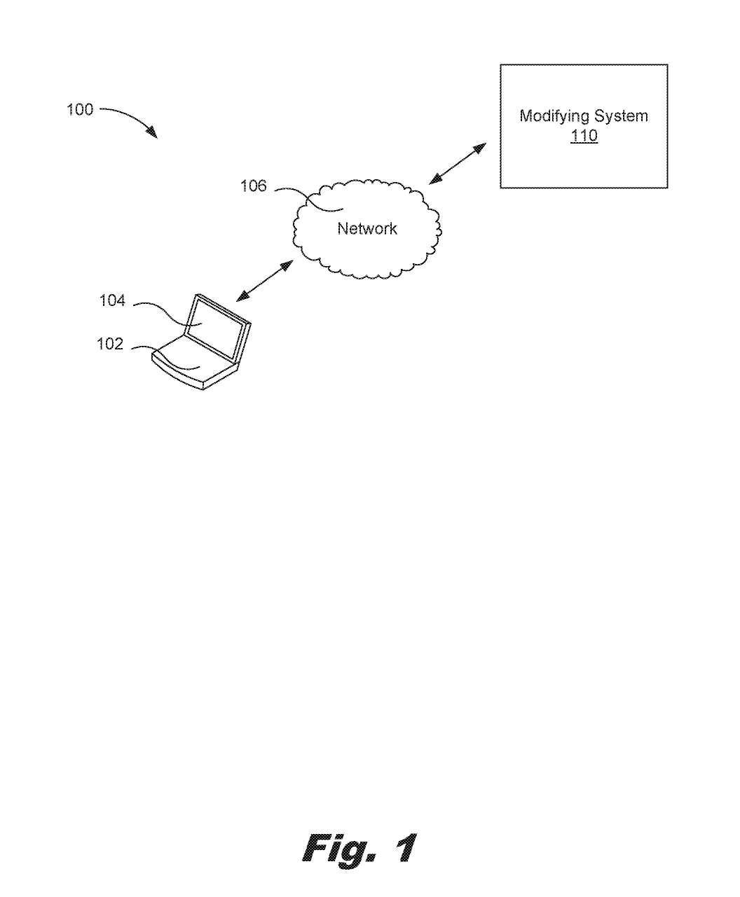

Referring now to the figures, FIG. 1 is a diagram of an example of a system for modifying a hierarchal structure, according to one example of principles described herein. As will be described below, a modifying system is in communication with a network to obtain, from a UI, data representing categories, levels for the categories, attributes associated with the levels for the categories, and attribute values associated with the attributes. Further, the modifying system restructures the data with content to generate a hierarchal structure, Further, the modifying system modifies, via the UI, the hierarchal structure based on modifications to the data and the content to generate a modified hierarchal structure.

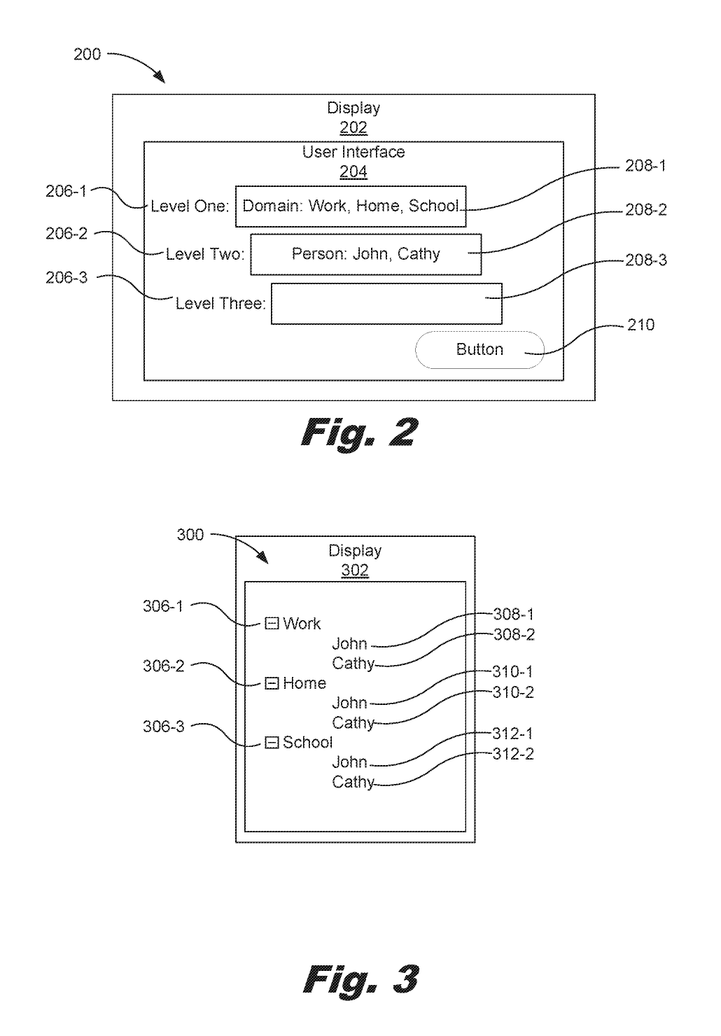

In one example, the system (100) includes a user device (102) with a display (104). In this example, the user device (102) allows a user to specify data via a UI displayed on the display (104). As mentioned above, the data is information that use is to define categories, levels for the categories, attributes associated with the levels for the categories, and attribute values associated with the attributes. More information about the UI will be described in FIG. 2.

The system (100) further includes a modifying system (110). be described in other parts of this specification, the modifying system (110) obtains, from the UI, the data representing categories, levels for the categories, attributes associated with the levels for the categories, and attribute values associated with the attributes. In one example, the data may be obtained from the user device (102).

The modifying system (110) further restructures the data with content to generate a hierarchal structure. In one example, the content may be generated by the user device (102) as a physical tree. In another example, the content may be generated by the user device (102) as a sub-tree.

The modifying system (110) further modifies, via the UI, the hierarchal structure based on modifications to the data and the content to generate a modified hierarchal structure. In one example, the user device (102) may be used to make modification to the data and the content via the UI that is displayed on the display (104). In another example, a different user device may be used to make modification to the data and the content.

The modifying system (110) further displays, to the user, the modified hierarchal structure. In this example, the modified hierarchal structure is displayed on the user device (102) via the display (104). As a result, the content is not flattened under the levels for the categories in the modified hierarchal structure. More information about the modifying system (110) will be described later on in this specification.

While this example has been described with reference to the modifying system being located over the network, the modifying system may be located in any appropriate location according to the principles described herein. For example, the modifying system may be located in a user device, a server, a datacenter, other locations, or combinations thereof.

While this example has been described with reference to using a UI to define the data, other methods and devices may be used. For example, a database, a server, a function, other methods and devices, or combinations thereof may be used to define the data.

FIG. 2 is a diagram of an example of a UI for defining categories, levels for the categories, attributes associated with the levels for the categories, and attribute values associated with the attributes, according to one example of principles described herein. As mentioned above, a user device may be used to specify, via a UI displayed on a display, data representing categories, levels for the categories, attributes associated with the levels for the categories, and attribute values associated with the attributes.

In one example, a display (202) displays a UI (204) to a user. As illustrated in FIG. 2, the UI (204) includes a number of levels (206). In this example, the levels (206) are used to arrange categories, attributes, and attributes values in a specific hierarchal order. In this example, the levels (206) may include level one (206-1), level two (206-2), and level three (206-3).

Level one (206-1) indicates the highest level for the categories. In this example, level one (206-1) includes a text box (208-1) to allow a user to specify an attribute associated with level one (206-1) and attribute values associated with the attributes. As illustrated, the user specifies domain to be an attribute associated with level one (206-1). Further, the user specifies work, home, and school to be attribute values associated with domain. In this example, the attribute and the attribute values are the categories for level one (206-1).

As mentioned above, the levels (206) may include level two (206-2). Level two (206-2) indicates the next highest level of the categories. In this example, level two (206-2) includes a text box (208-2) to allow the user to specify an attribute associated with level tow (206-2) and attribute values associated with the attributes. As illustrated, the user specifies person to be an attribute associated with level two (206-2). Further, the user specifies John and Cathy to be attribute values associated with person. In this example, the attribute and the attribute values are the categories for level two (206-2).

As illustrated in FIG. 2, the user does not specify level three (206-3). As a result, the text box (208-3) for level three (206-3) is left empty. Further, since level three's text box (208-3) is left empty, there are no attributes associated with the level three (206-3) and there are no attribute values associated with the attributes. Once all of the data is specified in the UI (204), the user may select a button (210) to generate the category hierarchical structure of FIG. 3.

While this example has been described with reference to the UI including three levels, the UI may include any number of levels. For example, the UI may include two levels. In another example, the UI may include ten levels.

While this example has been describe with reference to the UI including text boxes to set the attributes and the corresponding attribute values, the UI may include other data editors such as dropdown list, date picker, auto completion editors, other data editors, or combinations thereof.

FIG. 3 is a diagram of an example of a category hierarchical structure representing defined categories, levels for the categories, attributes associated with the levels for the categories, and attribute values associated with the attributes, according to one example of principles described herein. As mentioned above, once all of the data is specified in the UI, the user may select a button to generate the category hierarchical structure. In one example, the category hierarchical structure does not include content.

As illustrated in FIG. 3, the category hierarchical structure (300) represents defined categories, levels for the categories, attributes associated with the levels for the categories, and attribute values associated with the attributes of FIG. 2. Further, the category hierarchical structure (300) is displayed to the user via a display (302).

As mentioned in FIG. 2, the attribute values such as work, home, and school are associated with the attribute domain. Further, the attribute domain is associated with the highest level, level one. As a result, the category hierarchical structure (300) includes work (306-1), home (306-2) and school (306-3) as the highest level.

As mentioned in FIG. 2, the attribute values such as John and Cathy are associated with the attribute person, the next highest level, level two. As a result, the category hierarchical structure (300) includes John (308-1) and Cathy (308-2) associated with work (306-1). The category hierarchical structure (300) includes John (310-1) and Cathy (310-2) associated with home (306-2). The category hierarchical structure (300) further includes John (312-1) and Cathy (312-2) associated with school (306-3).

While this example has been describe with reference to the UI including text boxes to set the attributes and the corresponding attribute values, the UI may include other data editors such as dropdown list, date picker, auto completion editors, other data editors, or combinations thereof.

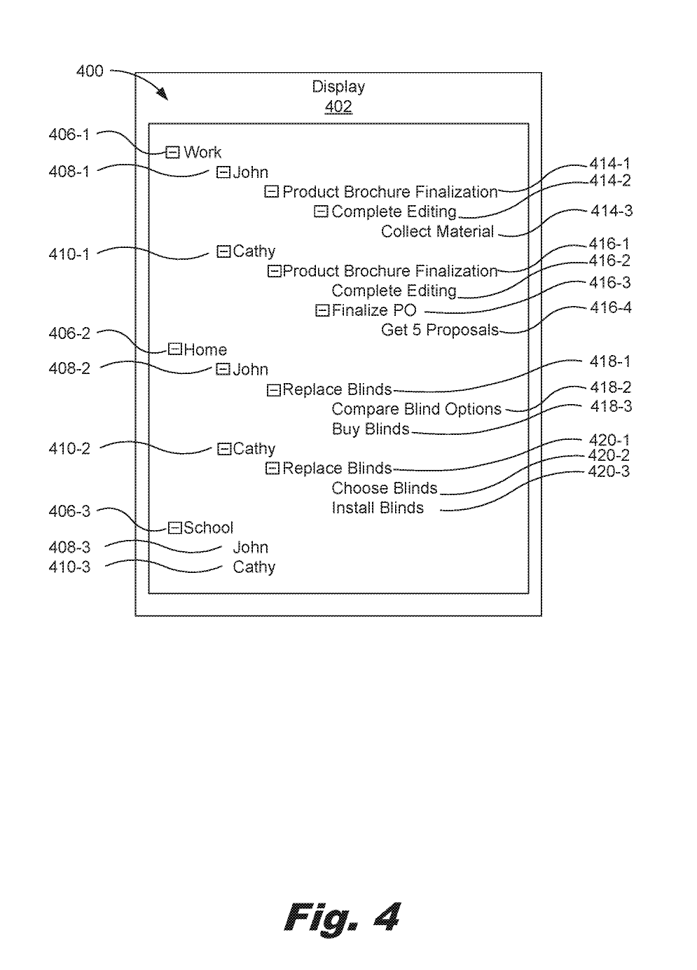

FIG. 4 is a diagram of an example of a hierarchical structure, according to one example of principles described herein. As mentioned above, the modifying system restructures data with content to generate a hierarchal structure. In one example, under each terminal category entry, in the example of FIG. 3, John and Cathy, the physical content structure will be displayed showing content that either directly corresponds to the categories' attribute values or are ancestors of an entry corresponding to the categories.

In one example, new content associated with the attributes may be added using a data structure such as a physical tree. In one example, the physical tree may be as follows:
Product Brochure Finalization (Domain=Work, Person=NA, Priority=High)
   Complete Editing (Domain=Work, Person=Cathy, Priority=High)
      Collect Material (Domain=Work, Person=John, Priority=High)
      Purchase Images (Domain=Work, Person=Maria, Priority=Medium)
      Produce PDF (Domain=Work, Person=Maria, Priority=High)
   Finalize PO (Domain=Work, Person=Randy, Priority=Low)
      Get 5 proposals (Domain=Work, Person=Cathy, Priority=Low)
      Select vendor (Domain=Work, Person=Melanie, Priority=Low)
      Issue PO (Domain=Work, Person=Randy, Priority=Medium)
Replace Blinds (Domain=Home, Person=John, Priority=High)
   Compare blinds options (Dornain=Home, Person=John, Priority=Low)
   Choose blinds (Domain=Home, Person=Cathy, Priority=High)
   Buy Blinds (Domain=Home, Person=John, Priority=High)
   Install Blinds (Domain=Home, Person=Cathy, Priority=Medium) (Physical Tree)
      In this example, the physical tree includes content. Further, the brackets are used as a way to show attribute values. For example, the second line of the physical tree is Complete Editing (Domain=Work, Person=Cathy, Priority=High). In this example, complete editing represents the content, Further, this content is to be placed in the hierarchal structure in the domain attribute under high. This content is to be further placed under the attribute value work. Further, this content is to be further placed under Cathy. Similarly, the content for each line in the physical tree may be in the hierarchal structure according to the attribute values in the brackets.

As a result, the modifying system restructures data with content to generate the hierarchal structure as illustrated in FIG. 4. In this example, work (406-1), home (406-2), and school (406-3) represent the levels for the categories as defined in FIG. 2 as the highest level. Further, John (408) and Cathy (410) represent the levels for the categories as defined in FIG. 2 as the next highest level.

Collect material (414-3), complete editing (416-2), get 5 proposals (416-4), replace blinds (418-1), compare blind options (418-2), buy blinds (418-3), choose blinds (420-2), and install blinds (420-3) represents the content from the physical tree corresponding to the levels of categories.

Further, ancestor entries such as, product brochure finalization (414-1), complete editing (414-2), product brochure finalization (416-1), finalize PO (416-3), replace blinds (418-1), school (406-3), John (408-3), and Cathy (410-3) do not correspond to the levels of categories. However, they are displayed to maintain the hierarchical structure with regard to content.

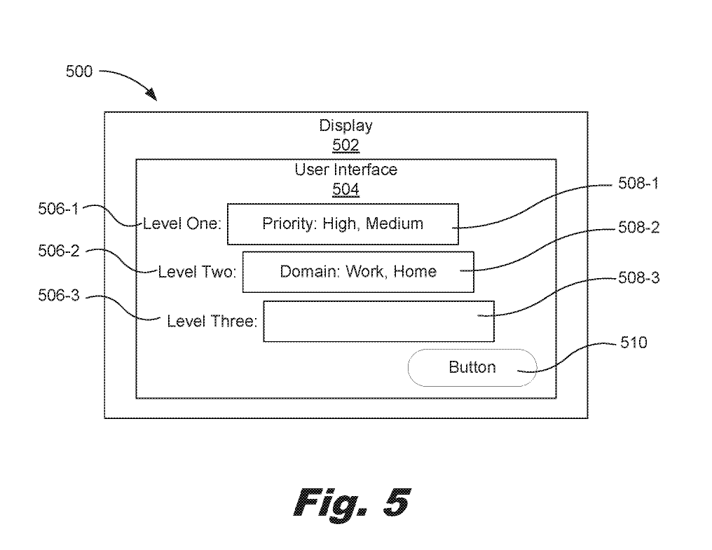

As will be described in FIG. 5, the user can now modify the hierarchical structure, via a UI, by reordering the levels for the categories, using different levels for the categories, defining new attributes, defining new attribute values, among others. Further, the modifying system of FIG. 1 maintains the physical structure despite modifying the hierarchical structure.

FIG. 5 is a diagram of an example of a UI for modifying the hierarchal structure, according to one example of principles described herein. As mentioned above, the modifying system allows a user to modify the hierarchal structure based on modifications to the data and the content that the user makes to generate a modified hierarchal structure.

In one example, a user may make modification to the data and the content via a UI (504) that is displayed on a display (502). As illustrated in FIG. 5, the UI (504) includes a number of levels (506). In this example, the levels (506) are used to modify categories, attributes, and attributes values in a specific hierarchal order. In this example, the levels (506) may include level one (506-1), level two (506-2), and level three (506-3). Level one (506-1) indicates the highest level for the categories. In this example, level one (506-1) includes a text box (508-1) to allow a user to specify an attribute associated with level one (506-1) and attribute values associated with the attributes. As illustrated, the user specifies, priority to be an attribute associated with level one (506-1). Further, the user specifies high and medium to be attribute values associated with priority.

As mentioned above, the levels (506) may include level two (506-2). Level two (506-2) indicates the next highest level for the categories. In this example, level two (506-2) includes a text box (508-2) to allow the user to specify an attribute associated with level two (506-2) and attribute values associated with the attributes. As illustrated, the user specifies, domain to be an attribute associated with level two (506-2). Further, the user specifies work and home to be attribute values associated with domain. As a result, since level one (506-1) is a higher level than level two (506-2), the attribute values for priority are a higher level than the attribute values for domain.

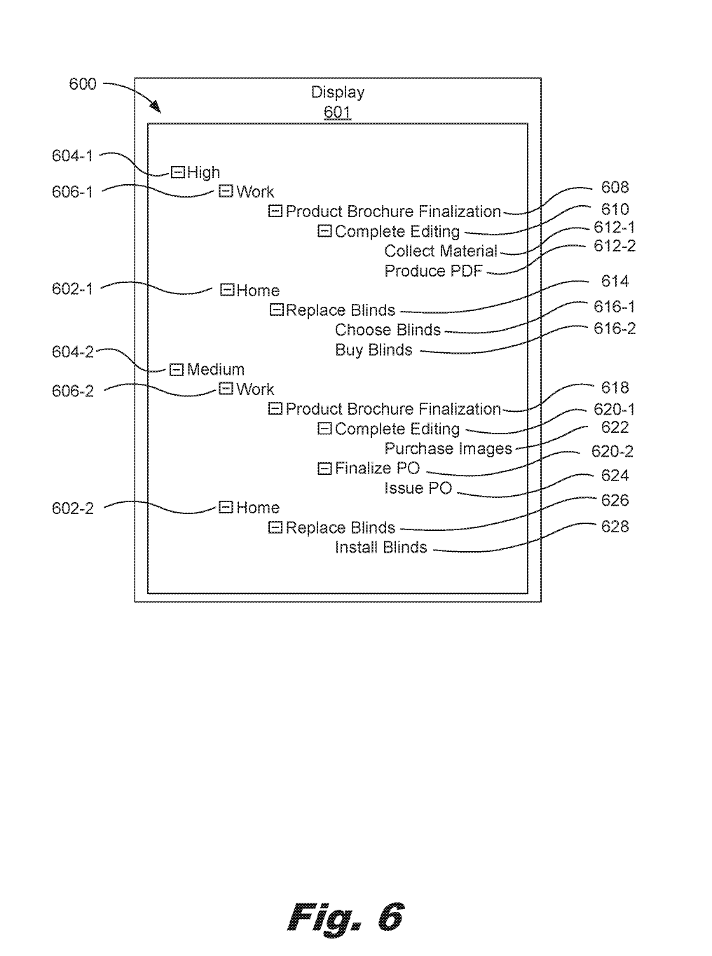

As illustrated in FIG. 5, the user does not specify level three (506-3). As a result, the text box (508-3) for level three (506-3) is left empty. Further, since level three's text box (508-3) is left empty, there are no attributes associated with the level three (506-3) and there are no attribute values associated with the attributes. Once all of the data is specified in the UI (504), the user may select a button (510) to generate the modified hierarchical structure of FIG. 6.

While this example has been described with reference to the UI including three levels, the UI may include any number of levels. For example, the UI may include two levels. In another example, the UI may include ten levels.

Further, while this example has been describe with reference to the UI including text boxes to set the attributes and the corresponding attribute values, the UI may include other data editors such as dropdown list, date picker, auto completion editors, other data editors, or combinations thereof.

Still further, while this example has been described with reference to the user specifying the data for the levels, the data for the levels may be specified by other methods. For example, the data for the levels may be specified by a function, a system, another user, among others.

FIG. 6 is a diagram of an example of a modified hierarchal structure, according to one example of principles described herein. In this example, high (604-1) and medium (604-2) represent the levels for the categories as defined in FIG. 5 as the highest level. Work (606) and home (602) represent the levels for the categories as defined in FIG. 5 as the next highest level.

Content such as product brochure finalization (608), complete editing (610), collect material (612-1), produce PDF (612-2), replace blinds (614), choose blinds (616-1), buy blinds (616-2), purchase images (622), issue PO (624), and install blinds (628) represents the content from the physical tree corresponding to the levels for the categories as described in FIG. 4.

Further, ancestor entries such as, product brochure finalization (618), complete editing (620-1), finalize PO (620-2), and replace blinds (626), do not correspond to the levels for the categories. However, they are displayed to maintain the hierarchical structure with regard to content.

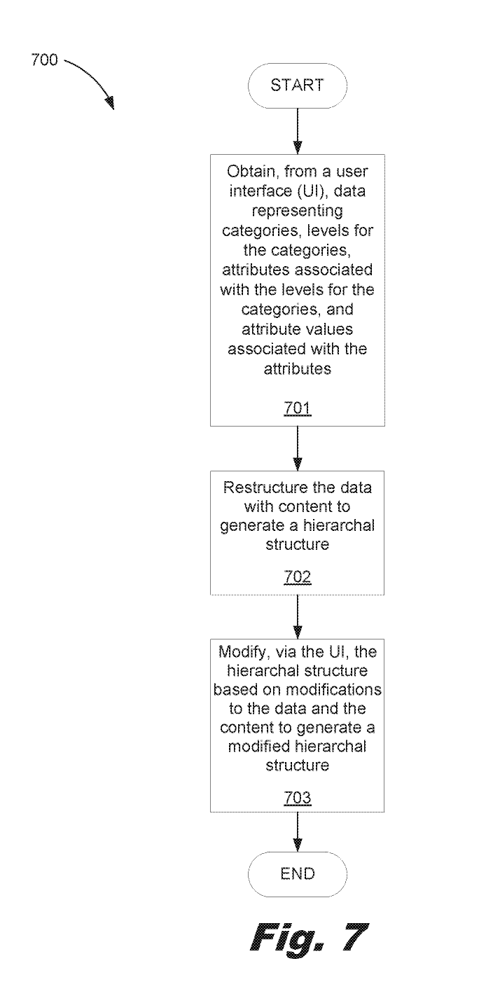

FIG. 7 is a flowchart of an example of a method for modifying a hierarchal structure, according to one example of principles described herein. In one example, the method (700) may be executed by the system (100) of FIG. 1. In other examples, the method (700) may be executed by other systems such as system 900 or system 1000. In this example, the method (700) includes obtaining (701), from a UI, data representing categories, levels for the categories, attributes associated with the levels for the categories, and attribute values associated with the attributes, restructuring (702) the data with content to generate a hierarchal structure, and modifying (703), via the UI, the hierarchal structure based on modifications to the data and the content to generate a modified hierarchal structure.

As mentioned above, the method (700) includes obtaining (701), from the UI, data representing categories, levels for the categories, attributes associated with the levels for the categories, and attribute values associated with the attributes. As mentioned above, the data may be specified by a user via the UI. For example, a user may specify the data via the UI of FIG. 2. Once all the data is specified by the user, the method (700) obtains the data from the user device.

As mentioned above, the method (700) includes restructuring (702) the data with content to generate a hierarchal structure. As mentioned above, the data that is obtained may be restructured with the content of a data structure such as a physical tree. As mentioned in FIG. 4, the physical tree may include content that is associated with the data.

In one example, only the content of the physical tree that is associated with the data may be restructured to generate the hierarchal structure. In another example, all the content of the physical tree that may or may not be associated with the data may be restructured to generate the hierarchal structure. In yet another example, content of a sub-tree, the sub-tree corresponding to the physical tree, that is associated with the data may be may be restructured to generate the hierarchal structure.

As mentioned above, the method (700) includes modifying (703), via the UI, the hierarchal structure based on modifications to the data and the content to generate a modified hierarchal structure. In one example, modifying the hierarchal structure based on the modifications to the data and the content to generate the modified hierarchal structure includes adding new content associated with the attributes corresponding to the levels for the categories.

In this example, the method (700) populates the attributes corresponding to the levels for the categories with the proper attribute values. While this example has been described with reference to adding new content associated with the attributes, content that is associated with the attributes may also be removed instead of added.

In another example, modifying, via the UI, the hierarchal structure based on the modifications to the data and the content to generate the modified hierarchal structure includes merging a sub-tree from one of the levels for the categories to a different level for the categories. In this example, the sub-tree may be a section corresponding to the physical tree. In this example, a drag and drop function may be used to merge the sub-tree from one of the levels for the categories to the different level for the categories. In one example, this may set the proper attribute values for the sub-tree.

In one example, merging the sub-tree from one of the levels for the categories to the different level for the categories includes updating all the attributes associated with the sub-tree to match the attribute values. In another example, merging the sub-tree from one of the levels for the categories to the different level for the categories includes updating the attributes associated with the content in the sub-tree that match the attribute values of the levels for the categories. In this example, this may include the attributes the sub-tree was dragged from.

In yet another example, merging the sub-tree from one of the levels for the categories to the different level for the categories includes updating the attributes associated with a particular node of the sub-tree. In this example, a particular node of the sub-tree may include attributes that are to be updated. As a result, the attributes associated with the particular node of the sub-tree are updated.

In one example, when merging a sub-tree from one of the levels for the categories to a different level for the categories, the modifying system of FIG. 1 may select one of the above options to execute the merging. In another example, when merging a sub-tree from one of the levels for the categories to a different level for the categories, a user may select one of the above options to execute the merging.

As a result, the method (700) maintains the integrity of the hierarchal structure via the categories. By maintaining the integrity of the hierarchal structure, the content is not misrepresented context-wise in the modified hierarchal structure. As a result, multiple users in an organization can manage hierarchical structures more easily and efficiently and can reduce the cases of erroneous content and data in the modified hierarchal structure. Moreover, the ability to set the attributes that correspond to the categories enables a higher level of integrity for the data and the content associated with the modified hierarchal structure.

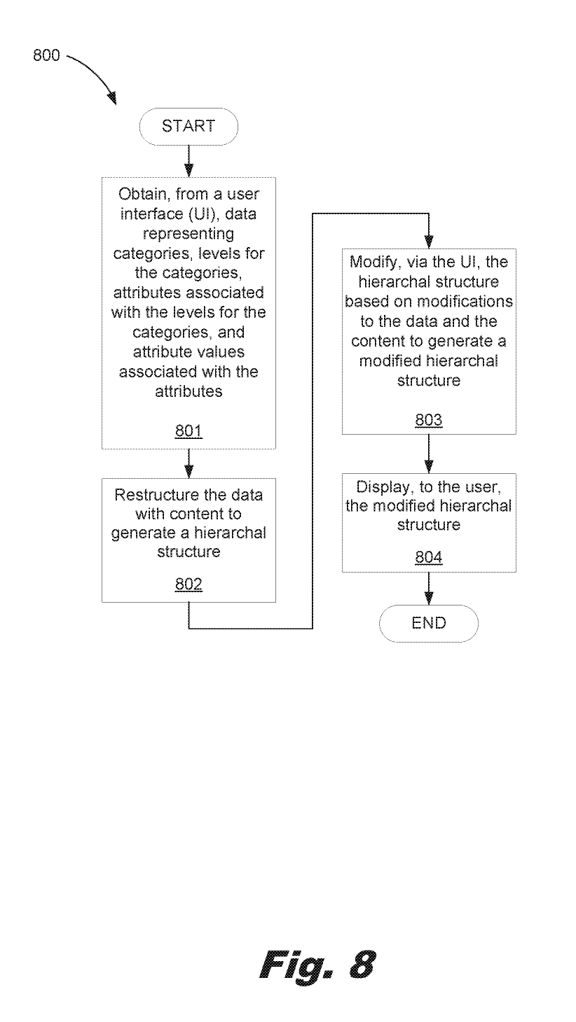

FIG. 8 is a flowchart of an example of a method for modifying a hierarchal structure, according to one example of principles described herein. In one example, the method (800) may be executed by the system (100) of FIG. 1. In other examples, the method (800) may be executed by other systems such as system 900 or system 1000. In this example, the method (800) includes obtaining (801), from a UI, data representing categories, levels for the categories, attributes associated with the levels for the categories, and attribute values associated with the attributes, restructuring (802) the data with content to generate a hierarchal structure, modifying (803), via the UI, the hierarchal structure based on modifications to the data and the content to generate a modified hierarchal structure, and displaying (804), to the user, the modified hierarchal structure.

As mentioned above, the method (800) includes displaying (804), to the user, the modified hierarchal structure. As mentioned above, once the hierarchal structure is modified, the modified hierarchal structure may be displayed to a user. In one example, the user may view the modified hierarchal structure via a display on a user device. As a result, the user as well as multiple users in an organization can view hierarchical structures more easily and efficiently and can reduce the cases of erroneous content and data.

Further, the method (800) allows the user to view the hierarchal structure that is restructured by a virtual and physical structure. Further, the user is able to dynamically modify the virtual structure of the modified hierarchal structure using the method (800). As a result, the method (800) provides greater flexibility and proper visualization of the modified hierarchal structure such that the content is not flattened under the levels for the categories in the modified hierarchal structure.

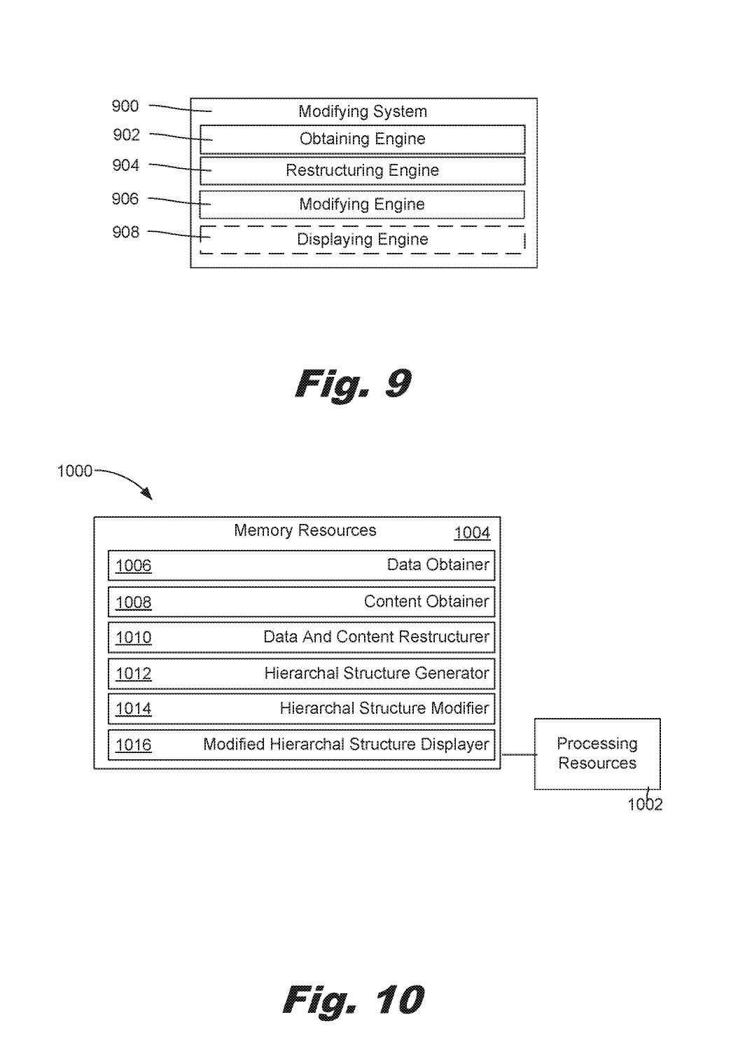

FIG. 9 is a diagram of an example of a modifying system, according to one example of principles described herein. The modifying system (900) includes an obtaining engine (902), a restructuring engine (904), and a modifying engine (906). In this example, the modifying system (900) also includes a displaying engine (908). The engines (902, 904, 906, 908) refer to a combination of hardware and program instructions to perform a designated function. Each of the engines (902, 904, 906, 908) may include a processor and memory. The program instructions are stored in the memory and cause the processor to execute the designated function of the engine.

The obtaining engine (902) obtains, from a UI, data representing categories, levels for the categories, attributes associated with the levels for the categories, and attribute values associated with the attributes. In one example, the user may specify the data via a UI. Once the user specifies the data via the UI, the obtaining engine (902) obtains the data as described above.

The restructuring engine (904) restructures the data with content to generate a hierarchal structure. In one example, the content may be from a data structure such as a physical tree. Further, the restructuring engine (904) may merge some content of a sub-tree, corresponding to the physical tree, to the data. In another example, the restructuring engine (904) may restructure all of the content corresponding to the physical tree to the data.

The modifying engine (906) modifies, via the UI, the hierarchal structure based on modifications to the data and the content to generate a modified hierarchal structure. In one example, the modifications may include adding new content associated with the attributes. In another example, the modifications may include merging a sub-tree from one of the levels for the categories to a different level for the categories. In one example, merging a sub-tree from one of the levels for the categories to a different level for the categories includes updating all the attributes associated with the sub-tree to match the attribute values, updating the attributes associated with the content in the sub-tree that match the attribute values of the levels for the categories, updating the attributes associated with a particular node of the sub-tree, or combinations thereof.

The displaying engine (908) displays, to the user, the modified hierarchal structure. In another example, the displaying engine (908) displays, to a group of users such as an organization, the modified hierarchal structure.

FIG. 10 is a diagram of an example of a modifying system, according to one example of principles described herein. In this example, the modifying system (1000) includes processing resources (1002) that are in communication with memory resources (1004). Processing resources (1002) include at least one processor and other resources used to process programmed instructions. The memory resources (1004) represent generally any memory capable of storing data such as programmed instructions or data structures used by the modifying system (1000). The programmed instructions shown stored in the memory resources (1004) include a data obtainer (1006), a content obtainer (1008), a data and content restructurer (1010), a hierarchal structure generator (1012), a hierarchal structure modifier (1014), and a modified hierarchal structure displayer (1016).

The memory resources (1004) include a computer readable storage medium that contains computer readable program code to cause tasks to be executed by the processing resources (1002). The computer readable storage medium may be non-transitory and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The data obtainer (1006) represents programmed instructions that, when executed, cause the processing resources (1002) to obtain, from a UI, data representing categories, levels for the categories, attributes associated with the levels for the categories, and attribute values associated with the attributes. The content obtainer (1008) represents programmed instructions that, when executed, cause the processing resources (1002) to obtain content from a data structure such as a physical tree.

The data and content restructurer (1010) represents programmed instructions that, when executed, cause the processing resources (1002) to restructure the data with content. The hierarchal structure generator (1012) represents programmed instructions that, when executed, cause the processing resources (1002) to generate a hierarchal structure based on the data that is restructured with the content.

The hierarchal structure modifier (1014) represents programmed instructions that, when executed, cause the processing resources (1002) to modify, via the UI, the hierarchal structure based on modifications to the data and the content to generate a modified hierarchal structure. The modified hierarchal structure displayer (1016) represents programmed instructions that, when executed, cause the processing resources (1002) to display, to the user, the modified hierarchal structure.

Further, the memory resources (1004) may be part of an installation package. In response to installing the installation package, the programmed instructions of the memory resources (1004) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (1002) and the memory resources (1002) are located within the same physical component, such as a server, or a network component. The memory resources (1004) may be part of the physical component's main memory, caches, registers, non-volatile memory, or elsewhere in the physical component's memory hierarchy. Alternatively, the memory resources (1004) may be in communication with the processing resources (1002) over a network. Further, the data structures, such as the libraries, may be accessed from a remote location over a network connection while the programmed instructions are located locally. Thus, the modifying system (1000) may be implemented on a user device, on a server, on a collection of servers, or combinations thereof.

The modifying system (1000) of FIG. 10 may be part of a general purpose computer. However, in alternative examples, the modifying system (1000) is part of an application specific integrated circuit.

The preceding description has been presented to illustrate and describe examples of the principles described, This description is not intended to be exhaustive or to limit these principles to any precise form disclosed. Many modifications and variations are possible in light of the above teaching.

What is claimed is:

1. A method for modifying a hierarchal structure, the method comprising:
obtaining, from a user interface (UI), data representing categories, levels for the categories, attributes associated with the categories, and attribute values associated with the attributes;
restructuring the data with content to generate a hierarchal structure; and
modifying, via the UI, the hierarchal structure based on modifications to the data and the content to generate a modified hierarchal structure.

2. The method of claim 1, in which modifying the hierarchal structure based on the modifications to the data and the content to generate the modified hierarchal structure comprises adding new content associated with the attributes.

3. The method of claim 1, in which modifying the hierarchal structure based on the modifications to the data and the content to generate the modified hierarchal structure comprises merging a sub-tree from one of the levels for the categories to a different level for the categories.

4. The method of claim 3, in which merging the sub-tree from one of the levels for the categories to the different level for the categories comprises updating all attributes associated with the sub-tree to match the attribute values.

5. The method of claim 3, in which merging the sub-tree from one of the levels for the categories to the different level for the categories comprises updating attributes associated with content in the sub-tree that match the attribute values of the levels for the categories.

6. The method of claim 3, in which merging the sub-tree from one of the levels for the categories to the different level for the categories comprises updating attributes associated with a particular node of the sub-tree.

7. The method of claim 1, further comprising displaying, to the user, the modified hierarchal structure.

8. A system for modifying a hierarchal structure, the system comprising:
an obtaining engine to obtain, from a user interface (UI), data representing categories, levels for the categories, attributes associated with the categories, and attribute values associated with the attributes;
a restructuring engine to restructure the data with content to generate a hierarchal structure;
a modifying engine to modify, via the UI, the hierarchal structure based on modifications to the data and the content to generate a modified hierarchal structure; and
a displaying engine to display, to the user, the modified hierarchal structure.

9. The system of claim 8, in which the modifying engine modifies the hierarchal structure based on the modifications to the data and the content to generate the modified hierarchal structure by adding new content associated with the attributes.

10. The system of claim 8, in which the modifying engine further modifies the hierarchal structure based on the modifications to the data and the content to generate the modified hierarchal structure by merging a sub-tree from one of the levels for the categories to a different level for the categories.

11. The system of claim 10, in which merging the sub-tree from one of the levels for the categories to the different level for the categories comprises updating all attributes associated with the sub-tree to match the attribute values, updating attributes associated with content in the sub-tree that match the attribute values of the levels for the categories, updating attributes associated with a particular node of the sub-tree, or combinations thereof.

12. A computer program product for modifying a hierarchal structure, comprising:
a tangible computer readable storage medium, said tangible computer readable storage medium comprising computer readable program code embodied therewith, said computer readable program code comprising program instructions that, when executed, causes a processor to:
restructure data with content to generate a hierarchal structure;
modify, via a user interface (UI), the hierarchal structure based on modifications to the data and the content to generate a modified hierarchal structure: and
display, to the user, the modified hierarchal structure,

13. The product of claim 12, further comprising computer readable program code comprising program instructions that, when executed, cause said processor to obtain, from the UI, data representing categories, levels for the categories, attributes associated with the categories, and attribute values associated with the attributes,

14. The product of claim 12, further comprising computer readable program code comprising program instructions that, when executed, cause said processor to add new content associated with the attributes.

15. The product of claim 12, further comprising computer readable program code comprising program instructions that, when executed, cause said processor to merge a sub-tree from one of the levels for the categories to a different level for the categories.
